(19) United States
(12) Patent Application Publication
(10) Pub. No.: US 2020/0016857 A1
(43) Pub. Date: Jan. 16, 2020

(54) METHOD AND APPARATUS FOR WINDING STRIP-SHAPED RUBBER MEMBER

(71) Applicant: BRIDGESTONE CORPORATION, Chuo-ku, Tokyo (JP)

(72) Inventor: Toru ICHINOHE, Chuo-ku, Tokyo (JP)

(21) Appl. No.: 16/487,093

(22) PCT Filed: Feb. 13, 2018
(86) PCT No.: PCT/JP2018/004942

§ 371 Date: Aug. 20, 2019

(30) Foreign Application Priority Data
Feb. 21, 2017 (JP) 2017-030533

(51) Int. Cl. B29D 30/60; B29D 30/16

(52) U.S. Cl. CPC B29D 30/60; B29D 30/1628

(57) ABSTRACT

In a device for winding a strip-shaped rubber member, a measured width and a measured thickness of a strip-shaped rubber member immediately before winding are measured by a measuring section at measurement point P. On the other hand, from a target width and a target thickness of the strip-shaped rubber member that are derived from a target sectional shape of a tread, an estimated width and an estimated thickness of the strip-shaped rubber member at the measurement point P are determined while taking deformation of the strip-shaped rubber member into consideration. Differences between the measured width and the estimated width, and between the measured thickness and the estimated thickness at each corresponding length direction position are determined.

### TECHNICAL FIELD

The present disclosure relates to a method of and a device for winding a strip-shaped rubber member that overlappingly wind a strip-shaped rubber member plural times onto the outer periphery of a toroidal tire intermediate and form a tread.

### BACKGROUND ART

The technique disclosed in, for example, Japanese Patent Application Laid-Open (JP-A) No. 2011-183623 is known as a conventional method for winding a strip-shaped rubber member.

This technique has a rotating section that rotates a toroidal tire intermediate around an axis, and a supplying section that supplies a strip-shaped rubber to and winds the strip-shaped rubber member plural times onto the outer periphery of the tire intermediate and forms a tread that has a target sectional shape. Due to the supplying section being set so as to be apart from the tire intermediate, the strip-shaped rubber member that is between the supplying section and the tire intermediate is made to travel in the air.

### SUMMARY OF INVENTION

### Technical Problem

In this way, in the conventional technique, an attempt is made to form a tread of a target sectional shape by overlappingly winding a strip-shaped rubber member onto the outer periphery of a tire intermediate. However, it is often the case that the cross-sectional shape of the actual tread that is formed deforms in the midst of being supplied to the tire intermediate. Therefore, there are often cases in which the cross-sectional shape differs from the target sectional shape. Furthermore, there is the problem that the cross-sectional shape of the aforementioned actual tread can only be known by, after the formation thereof, cutting the green tire along the meridian and observing the cut surface.

An object of the present disclosure is to provide a method of and a device for winding a strip-shaped rubber member that, in the midst of overlapping winding a strip-shaped rubber member onto a tire intermediate, can easily infer the wound state of the strip-shaped rubber member without carrying out cutting.

### Solution to Problem

Such an object can be achieved by a method for winding a strip-shaped rubber member that, at a time of overlappingly winding a strip-shaped rubber member plural times onto an outer periphery of a tire intermediate that is toroidal and rotates around an axis, and forming a tread of a target sectional shape, measures a width and a thickness at each length direction position of the strip-shaped rubber member immediately before winding as a measured width and a measured thickness, respectively, at measurement point P that is apart from the tire intermediate, and, from a target width and target thickness at each length direction position of the strip-shaped rubber member that have been derived from the target sectional shape, determines an estimated width and estimated thickness at each length direction position of the strip-shaped rubber member at the measurement point P while taking into consideration deformation of the strip-shaped rubber member from the measurement point P until reaching the tire intermediate, and determines differences between the measured width and the estimated width, and between the measured thickness and the estimated thickness at each corresponding length direction position.

### Advantageous Effects of Invention

In the present disclosure, the measured width and the measured thickness of the strip-shaped rubber member immediately before winding are measured at measurement point P. On the other hand, from the target width and the target thickness of the strip-shaped rubber member that are derived from the target sectional shape of the tread, an estimated width and an estimated thickness of the strip-shaped rubber member at the measurement point P are determined while taking into consideration deformation of the strip-shaped rubber member from the measurement point P until reaching the tire intermediate. The differences between the measured width and the estimated width, and between the measured thickness and the estimated thickness at each corresponding length direction position are determined. Accordingly, in the midst of winding the strip-shaped rubber member onto the tire intermediate, the wound state thereof, i.e., how close of a state to the target sectional shape the strip-shaped rubber member is being wound in, can easily be inferred, without cutting the strip-shaped rubber member that has been wound. Moreover, because the measured width and the measured thickness of the strip-shaped rubber member immediately before winding are measured at the measurement point P, the distance from the measurement point P to the tire intermediate is short, and the amount of deformation of the strip-shaped rubber member can be effectively reduced, and the aforementioned wound state can be inferred highly accurately.

### BRIEF DESCRIPTION OF DRAWINGS

FIG. 1 is a meridian sectional view showing a vulcanized tire of this embodiment.

FIG. 2 is a meridian sectional view of a tread that is structured by a flat, strip-shaped rubber member being wound overlappingly.

FIG. 3 is a partially broken plan view of the strip-shaped rubber member.

FIG. 4 is a schematic side view showing embodiment 1 of a winding device.

FIG. 5 is a sectional view seen in the direction of arrow I-I of FIG. 4.

FIG. 6 is a schematic side view showing embodiment 2 of a winding device.

### DESCRIPTION OF EMBODIMENTS

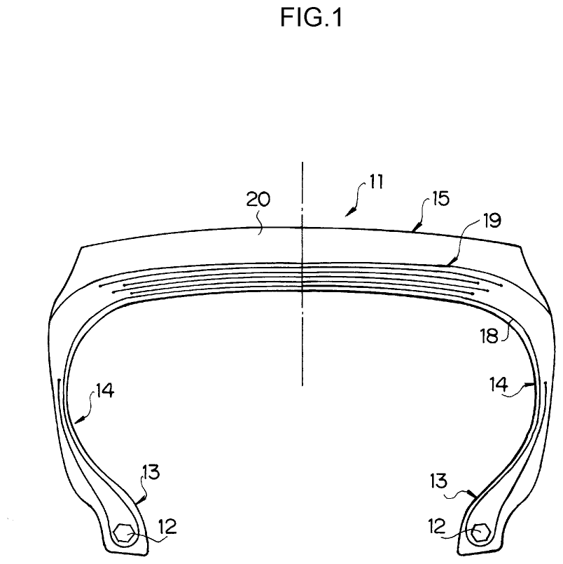

Embodiment 1 of this invention is described hereinafter on the basis of the drawings. In FIG. 1, 11 is a vulcanized pneumatic radial tire that is mounted to a large construction vehicle. This tire 11 has a pair of bead portions 13 in which ring-shaped beads 12 are embedded respectively, a pair of sidewall portions 14 that extend from these bead portions 13 substantially toward the radial direction outer side, and a tread portion 15 that is substantially shaped as a cylindrical tube and connects the radial direction outer ends of these sidewall portions 14. Further, this tire 11 is reinforced by a carcass layer 18 that is formed in a toroidal shape and that extends from one of the bead portions 13 to the other of the bead portions 13. The width direction both end portions of this carcass layer 18 are folded-over around the beads 12. A belt layer 19 is disposed at the radial direction outer side of the carcass layer 18. Moreover, a tread 20, at which wide grooves are formed in the outer surface (the road-contacting surface), is disposed at the radial direction outer side of this belt layer 19. Here, the tread 20 such as described above is formed due to a thin, elongated, strip-shaped rubber member being supplied to and being wound overlappingly plural times, e.g., 30 to 40 times, successively toward the radial direction outer side onto the outer periphery of an unvulcanized tire intermediate that has a toroidal shape, and thereafter, vulcanization being carried out. As a result, the width of the strip-shaped rubber member at respective positions in the radial direction of the tread 20 corresponds to the width of the tread 20 at those positions.

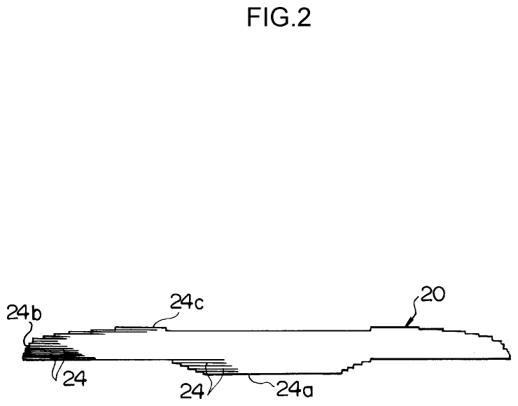

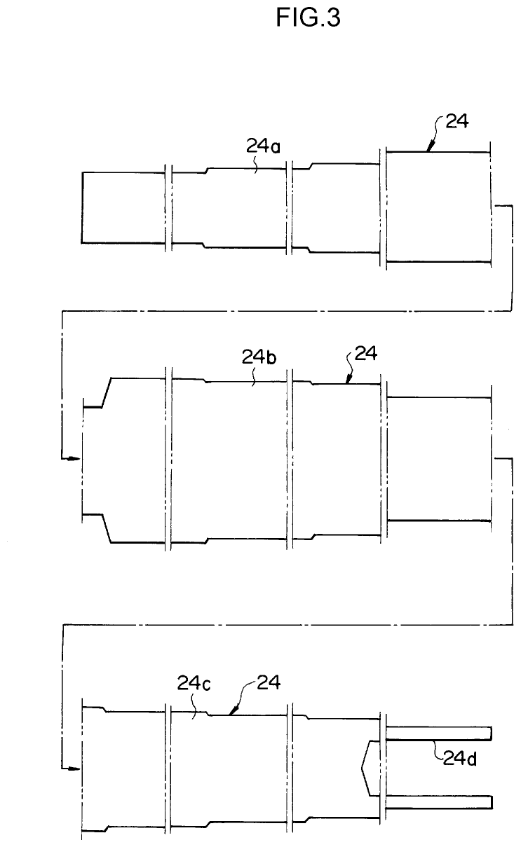

Further, the meridian sectional shape of a structure that is formed by an above-described strip-shaped rubber member 24 being wound plural times in a cylindrical tubular form in a flat state, i.e., without being deformed in the radial direction at any of the width direction regions thereof, is shown in FIG. 2. Further, at starting end portion 24a of the strip-shaped rubber member 24, as shown in FIGS. 2 and 3, the width is less than or equal to half of the width at a central portion 24b , and gradually becomes wider each one time around or each plural times around the tire intermediate. On the other hand, although the central portion 24b of the strip-shaped rubber member 24 is wide, the width thereof gradually becomes more narrow each one time around or each plural times around the tire intermediate. Moreover, the width of a final end portion 24c of the strip-shaped rubber member 24 is slightly narrower than the width of the central portion 24b , and gradually becomes more narrow each one time around or each plural times around the tire intermediate. Slits 24d that extend in the length direction are formed in the width direction central portion of the strip-shaped rubber member 24.

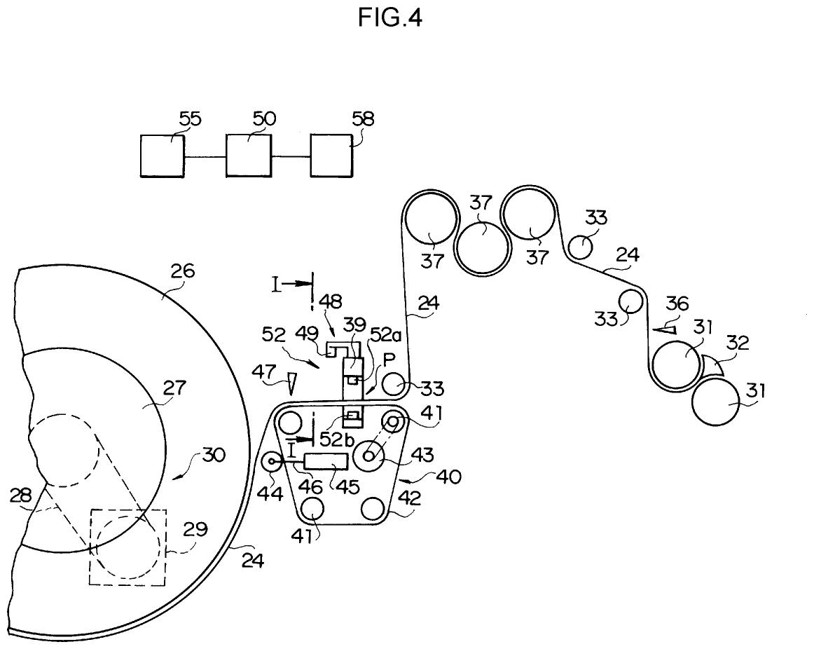

Here, the tread 20 such as described above can be structured by the strip-shaped rubber member 24 such as described above being supplied to and wound overlappingly plural times onto the outer periphery of a tire intermediate 26, which is formed from the beads, the carcass layer and the belt layer and is filled with internal pressure and is formed in a toroidal shape, by a winding device such as shown in FIG. 4. In this drawing, 27 is a supporting body that supports, in airtight states, the both bead portions 13 of the tire intermediate 26 that is filled with a predetermined internal pressure. Driving force of a driving motor 29 is transmitted to this supporting body 27 via a transmission belt 28. As a result, the tire intermediate 26 can be rotated around a horizontal axis integrally with the supporting body 27. The above-described supporting body 27, transmission belt 28 and driving motor 29 as a whole structure a rotating section 30 that rotates the toroidal tire intermediate 26 around the axis. Note that, in the present embodiment, the rotating section may be structured from a first gear that is formed at the supporting body, a second gear that meshes-together with the first gear, a driving motor that imparts driving rotational force to the second gear, and the like. A pair of calendar rollers 31, which rotate in opposite directions around axes parallel to the axis of the tire intermediate 26 by receiving rotational driving force from unillustrated driving motors, are disposed further toward the rear than the tire intermediate 26. Due to a bank of rubber 32, which is supplied to these calendar rollers 31, being passed between the calendar rollers 31 that are rotating, the strip-shaped rubber member 24, which is formed from an unvulcanized rubber and is wide and has a uniform thickness, is successively formed. Then, the strip-shaped rubber member 24 that is formed by the calendar rollers 31 is guided by plural guide rollers 33, and travels forward toward the tire intermediate 26 while being bent.

36 is a pair of cutters that are set between the calendar rollers 31 and the guide roller 33 that is nearest to the calendar rollers 31. Due to these cutters 36 cutting, in the length direction, the width direction both side portions of the strip-shaped rubber member 24 that is in the midst of traveling toward the tire intermediate 26, the width of the strip-shaped rubber member 24 can be adjusted as described above, and, due to the cutters 36 cutting and removing width direction central portions, the slits 24d are formed. Here, when changing the width of the strip-shaped rubber member 24, the cutters 36 are made to approach or are made to move away from one another. At this time, because the strip-shaped rubber member 24 is traveling toward the tire intermediate 26 as described above, the width direction both side ends of the strip-shaped rubber member 24 that remains are inclined with respect to the length direction at the positions where the width changes. 37 are three cooling rollers that are set between the cutters 36 and the tire intermediate 26, and that rotate around axes parallel to the axis of the tire intermediate 26 by receiving driving rotational force from an unillustrated driving motor. The strip-shaped rubber member 24 travels while successively being trained around the peripheries of these cooling rollers 37, and, on the other hand, cooling water or the like is circulated through the interiors of the cooling rollers 37, and, due thereto, the strip-shaped rubber member 24 is cooled to a desired temperature while being supplied.

40 is a supplying section that is set directly rearward of the tire intermediate 26 and between the tire intermediate 26 and the cooling rollers 37. This supplying section 40 is supported at a moving frame 39 (only a portion thereof is illustrated) that can move in the front-rear direction by an unillustrated moving portion. The supplying section 40 has plural rollers 41, plural, narrow, endless supplying belts 42 that are trained around the rollers 41 and are parallel to one another, and a driving motor 43 that imparts rotational driving force to any one of the rollers 41. Further, when the driving motor 43 operates and the rollers 41 rotate, the strip-shaped rubber member 24, which is transferred on the conveying portions of the horizontal supplying belts 42 that are positioned at the upper portion, is supplied toward the tire intermediate, and thereafter, hangs-down from the front end of the supplying section 40 (the conveying portion). 44 is an affixing roller that can freely rotate around an axis that is parallel to the axis of the tire intermediate 26. This affixing roller 44 is rotatably supported at the distal end of a piston rod 46 of a cylinder 45 that is supported at the moving frame 39. As a result, when the cylinder 45 operates and the piston rod 46 is projected-out and pulled-in, the affixing roller 44 approaches and moves away from the tire intermediate 26.

Further, when the strip-shaped rubber member 24, which hangs-down from the front end of the supplying section 40, is pushed against the outer periphery of the tire intermediate 26 by the affixing roller 44 that has moved to approach the tire intermediate 26, the strip-shaped rubber member 24 is press-fit to the periphery of the tire intermediate 26. At this time, when the strip-shaped rubber member 24 is supplied toward the tire intermediate 26, and on the other hand, the tire intermediate 26 is rotating, the strip-shaped rubber member 24 is successively wound overlappingly onto the outer periphery of the tire intermediate 26. Then, when a cutting position, which is apart by a predetermined length in the length direction from the starting end of the strip-shaped rubber member 24, arrives at directly beneath a cutter 47, the cutter 47 cuts the final end portion of the strip-shaped rubber member 24 at the cutting position. Thereafter, the remaining portion of the strip-shaped rubber member 24 is, while being pressed by the affixing roller 44, wound onto the outer periphery of the tire intermediate 26 until reaching the final end (the cut end). Due thereto, the tread 20 is formed by the strip-shaped rubber member 24, which is overlappingly wound plural times, on the periphery of the tire intermediate 26, and a green tire is formed. The above-described rollers 41, supplying belts 42, driving motor 43, affixing roller 44 and cylinder 45 on the whole structure the supplying section 40 that supplies and overlappingly winds the strip-shaped rubber member 24 plural times onto the outer periphery of the tire intermediate 26 and forms the tread 20 that has the target sectional shape. Note that, in the present embodiment, the supplying section may be structured from plural rollers that are disposed so as to be apart at a uniform distance in the length direction of the strip-shaped rubber member 24 and that extend in the width direction of the strip-shaped rubber member 24, and a driving motor that imparts driving rotational force to these rollers via belts, chains or the like and that synchronously rotates these rollers at a uniform speed.

Here, after the above-described strip-shaped rubber member 24 comes away from the front end of the supplying section 40, the strip-shaped rubber member 24 passes-through the air during the time until being pushed-against the tire intermediate 26 by the affixing roller 44. However, at this time, the peripheral speed of the outer periphery of the tire intermediate 26 (more exactly, the peripheral speed of the outermost layer of the strip-shaped rubber member 24 that is already wound on the tire intermediate 26) is a speed that is around 10% higher than the supplying speed of the strip-shaped rubber member 24 by the supplying section 40 (the traveling speed of the strip-shaped rubber member 24). Due thereto, tension in the length direction is imparted to the strip-shaped rubber member 24 that is traveling in the air, and the strip-shaped rubber member 24 is pulled and stretched in the length direction, and sagging of the strip-shaped rubber member 24 at the time of being supplied to the tire intermediate 26 is prevented. However, if the strip-shaped rubber member 24 is deformed, and, here, is pulled and stretched in the length direction, immediately before winding onto the tire intermediate 26 in this way, the sectional shape of the strip-shaped rubber member 24 after being wound onto the tire intermediate 26 changes from the sectional shape thereof at the time when the strip-shaped rubber member 24 is positioned on the supplying section 40, i.e., the width becomes narrower and the thickness becomes thinner. As a result, the sectional shape of the tread 20 after formation becomes a shape that differs from the target sectional shape that is the objective.

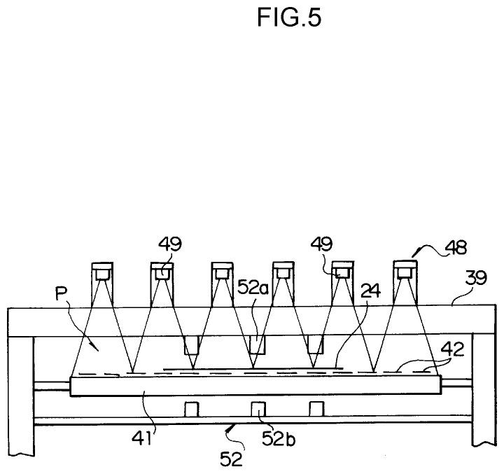

Therefore, in this embodiment, as shown in FIGS. 4 and 5, a measuring section 48 is set at measurement point P which is apart rearward from the tire intermediate 26, and the width and the thickness of the strip-shaped rubber member 24 immediately before winding are measured by the measuring section 48. Here, the measuring section 48 has plural pairs, and here, three pairs, of width measuring sensors 49 that are mounted to the moving frame 39 at the measurement point P. These plural pairs of width measuring sensors 49 are apart at a uniform distance in the width direction of the strip-shaped rubber member 24. The width measuring sensors 49 that together form a pair are disposed symmetrically across the width direction center of the strip-shaped rubber member 24. Here, image pickup tubes, two-dimensional laser sensors, or the like can be used as these width measuring sensors 49. The width of the strip-shaped rubber member 24 is measured by the width measuring sensors 49 that form any of the pairs. Further, at the strip-shaped rubber member 24, the width of the strip-shaped rubber member 24 at respective positions in the length direction of the strip-shaped rubber member 24 are measured, and these measured values (measured widths) are successively outputted to a difference acquiring section 50. In this way, at the measurement point P, the plural pairs of width measuring sensors 49, which are apart in the width direction of the strip-shaped rubber member 24, which are disposed so as to be symmetrical across the width direction center of the strip-shaped rubber member 24, are set, and the width of the strip-shaped rubber member 24 is measured by the width measuring sensors 49 that form any of the pairs. Therefore, even in a case in which the width of the tread 20 of the tire intermediate 26 (the width of the strip-shaped rubber member 24) varies greatly due to an increase/decrease in the diameter of the tire intermediate 26, the width measuring sensors 49 that form any of the pairs can measure the width of the strip-shaped rubber member 24. Due thereto, the width of the strip-shaped rubber member 24 can be measured rapidly and highly accurately.

Further, the measuring section 48 has plural, and here, three, thickness measuring sensors 52 that are mounted to the moving frame 39 at the measurement point P. These thickness measuring sensors 52 are disposed at the width direction center of the strip-shaped rubber member 24 and at positions that are apart from the width direction center at a uniform distance at the width direction both sides. Here, opposing laser gauge sensors, magnetic thickness meters, electrostatic capacitive thickness meters, or the like can be used as these thickness measuring sensors 52. The thickness measuring sensor 52 is structured from an upper sensor piece 52a that is positioned at the upper side of the strip-shaped rubber member 24 that is being supplied, and a lower sensor piece 52b that is positioned directly beneath the upper sensor piece 52a at the lower side of the strip-shaped rubber member 24. Further, the thickness measuring sensors 52 measure the thickness of the strip-shaped rubber member 24 at the respective length direction positions of the strip-shaped rubber member 24. These measured values (measured thicknesses) are successively outputted to the difference acquiring section 50. The above-described width measuring sensors 49 and thickness measuring sensors 52 on the whole structure the measuring section 48 that respectively measures the width and the thickness of the strip-shaped rubber member 24 immediately before winding, as the measured width and the measured thickness at the measurement point P that is apart from the tire intermediate 26.

55 is a storage that stores target widths, target thicknesses at the respective length direction positions of the strip-shaped rubber member 24 that are derived from the target sectional shape of the above-described tread 20. Here, the target widths, the target thicknesses are the widths, the thicknesses at the respective length direction positions of the strip-shaped rubber member 24, at the time when the tread 20, which has the target sectional shape that is determined in the stage of designing the tire, is structured by the strip-shaped rubber member 24 that is thin being wound overlappingly predetermined times. Further, when the width measuring sensors 49, the thickness measuring sensors 52 are, as described above, measuring the width and the thickness of the strip-shaped rubber member 24 immediately before winding, the values of the target width and the target thickness are inputted to the difference acquiring section 50 from the storage 55. At this time, from the target width and the target thickness (on the basis of the target width and the target thickness) at each length direction position of the strip-shaped rubber member 24, the difference acquiring section 50 determines an estimated width and an estimated thickness at each length direction position of the strip-shaped rubber member 24 at the measurement point P (estimates the width and the thickness of a time when elongation, before the strip-shaped rubber member 24 of the target width and the target thickness is wound onto the tire intermediate 26, does not arise), while taking into consideration the elongation of the strip-shaped rubber member 24 that is due to the above-described speed difference from the measurement point P until reaching the tire intermediate 26. Here, estimation such as described above can be carried out by using coefficients and computational formulas that are derived from a large amount of data while taking into consideration the wound diameter, the rate of elongation, the material of the rubber, the temperature, the winding speed and the like, or by using a table of theoretical formulas that are derived theoretically or the like.

When the estimated width and the estimated thickness are determined in this way, the difference acquiring section 50, either successively and continuously or at each fixed distance, compares the measured width and the estimated width, and, the measured thickness and the estimated thickness at the same length direction position of the strip-shaped rubber member 24, and the differences between the measured width and the estimated width, and between the measured thickness and the estimated thickness at each length direction position of the strip-shaped rubber member 24 are determined by the difference acquiring section 50. At this time, in order to compare the values at the same length direction position of the strip-shaped rubber member 24, the operations of the rotating section 30 and the supplying section 40 (the rotation of the supporting body 27, the rollers 41) are detected by sensors such as unillustrated encoders or the like, and the results of detection are outputted to the difference acquiring section 50, and comparison of the same position is ensured. Next, these differences are displayed on an unillustrated display portion, and, due thereto, visualization of the wound state of the strip-shaped rubber member 24 (the sectional shape of the tread 20 after completion of winding) is achieved. Next, these differences are successively outputted to a judging section 58. The judging section 58 judges whether or not the differences between the above-described measured width, measured thickness and estimated width, estimated thickness are less than or equal to tolerances, and judges the quality of the winding of the strip-shaped rubber member 24. Due thereto, judgment on the quality of the winding of the strip-shaped rubber member 24 can be carried out easily.

Operation of above-described embodiment 1 is described next. When the strip-shaped rubber member 24 is to be wound onto the outer periphery of the tire intermediate 26, the calendar rollers 31 are rotated in opposite directions, and the strip-shaped rubber member 24, which is wide and has a uniform thickness, is formed from the bank of rubber 32 that passes between these calendar rollers 31. The starting end portion of the strip-shaped rubber member 24 that is formed in this way is grasped by an unillustrated starting end guiding member, and thereafter, the starting end guiding member moves along the traveling path of the strip-shaped rubber member 24. Due thereto, the strip-shaped rubber member 24 is supplied to the supplying section 40 while being successively trained around the guide rollers 33 and the cooling rollers 37, and a predetermined length thereof hangs-down from the front end of the supplying section 40. At this time, the width direction both side portions of the starting end portion of the strip-shaped rubber member 24 are cut in the length direction by the cutters 36, and the starting end portion 24a that has a relatively narrow width is formed. Further, at this time, the width measuring sensors 49, the thickness measuring sensors 52 detect the width and the thickness of the starting end portion 24a that passes by the measurement point P, and output the measured width and the measured thickness that are measured to the difference acquiring section 50.

Next, when the cylinder 45 is operated and the piston rod 46 is projected-out, the starting end portion 24a that is hanging-down from the front end of the supplying section 40 as described above is pushed against the tire intermediate 26 by the affixing roller 44 that has moved so as to approach the tire intermediate 26, and is press-fit onto the outer periphery of the tire intermediate 26. In this state, the calendar rollers 31 and the cooling rollers 37 are rotating by the driving motors, and the driving motor 43 of the supplying section 40 is operated and the supplying belts 42 are made to travel, and the strip-shaped rubber member 24 that has been formed by the calendar rollers 31 is made to travel toward the tire intermediate 26. At this time, the rotating section 30 is operated and the supporting body 27 and the tire intermediate 26 are rotated integrally, and the strip-shaped rubber member 24 that is supplied from the supplying section 40 to the tire intermediate 26 is successively wound onto the outer periphery of the tire intermediate 26 while being pushed by the affixing roller 44. At the time when the strip-shaped rubber member 24 is being wound onto the tire intermediate 26 in this way, in order to prevent a state in which the strip-shaped rubber member 24 goes slack in the air between the supplying section 40 and the tire intermediate 26, the peripheral speed of the outer periphery of the tire intermediate 26 (the peripheral speed of the outermost layer of the strip-shaped rubber member 24 that is wound on the tire intermediate 26) is made to be a speed that is approximately 10% higher than the traveling speed of the strip-shaped rubber member 24 (the speed of supplying the strip-shaped rubber member 24 to the tire intermediate 26). Due thereto, tension in the length direction is imparted to the strip-shaped rubber member 24 that is traveling in the air, and the strip-shaped rubber member 24 is pulled and stretched in the length direction. As a result, the sectional shape (the width and the thickness) of the strip-shaped rubber member 24 after winding onto the tire intermediate 26 varies from the sectional shape (the width and the thickness) thereof on the supplying section 40.

Therefore, in this embodiment, the measured width and the measured thickness of the strip-shaped rubber member 24 immediately before winding are measured by the measuring section 48 (the width measuring sensors 49, the thickness measuring sensors 52) at the measurement point P. These measured values are successively outputted to the difference acquiring section 50, and, on the other hand, the target width and the target thickness at each length direction position of the strip-shaped rubber member 24 that have been derived from the target sectional shape of the tread 20 are outputted from the storage 55 to the difference acquiring section 50. At this time, from the target width and the target thickness (on the basis of the target width and the target thickness) at each length direction position of the strip-shaped rubber member 24 that have been inputted from the storage 55, the difference acquiring section 50 determines an estimated width and an estimated thickness at each length direction position of the strip-shaped rubber member 24 at the measurement point P (estimates the width and the thickness of before elongation arises), while taking into consideration the elongation of the above-described strip-shaped rubber member 24 from the measurement point P until reaching the tire intermediate 26. Thereafter, the difference acquiring section 50 compares the measured width and the estimated width, and, the measured thickness and the estimated thickness at the same length direction position of the strip-shaped rubber member 24. The differences between the measured width and the estimated width, and between the measured thickness and the estimated thickness at each length direction position of the strip-shaped rubber member 24 are determined by the difference acquiring section 50, and visualization of the wound state of the strip-shaped rubber member 24 (the sectional shape of the tread 20 after winding is competed) is devised. In this way, even in a case in which the strip-shaped rubber member 24 is pulled and stretched immediately before winding onto the tire intermediate 26, differences from the state of the strip-shaped rubber member 24 at the time of winding, i.e., from the target winding state, can be inferred easily and highly accurately. Then, these differences are successively outputted to the judging section 58. At this time, the judging section 58 judges whether or not the above-described differences between the measured width and the estimated width, and between the measured thickness and the estimated thickness are less than or equal to tolerances, and judges the quality of the winding of the strip-shaped rubber member 24.

Further, when substantially the entire length of the strip-shaped rubber member 24 is wound on the tire intermediate 26, the cutter 47 that is set directly above the front end of the supplying section 40 cuts the strip-shaped rubber member 24. Thereafter, the remaining portion of the strip-shaped rubber member 24 that is positioned further toward the tire intermediate 26 side than the cut end is, due to the rotation of the tire intermediate 26, wound onto the periphery of the tire intermediate 26 while being pushed thereagainst by the affixing roller 44, and the strip-shaped rubber member 24 of a predetermined length is wound from the starting end to the final end thereof onto the tire intermediate 26. On the other hand, the strip-shaped rubber member 24 that is further toward the calendar roller 31 side than the cut end is pulled back into the bank of rubber 32 of the calendar rollers 31 due to the calendar rollers 31, the cooling rollers 37 and the rollers 41 rotating in reverse directions, and is readied for the next winding. Further, when there is a change in the diameter of the tire intermediate 26, the moving frame 39 and the supplying section 40 integrally approach or move away from the tire intermediate 26, and the interval between the supplying section 40 and the tire intermediate 26 is adjusted so as to be constant, regardless of changes in the diameter of the tire intermediate 26.

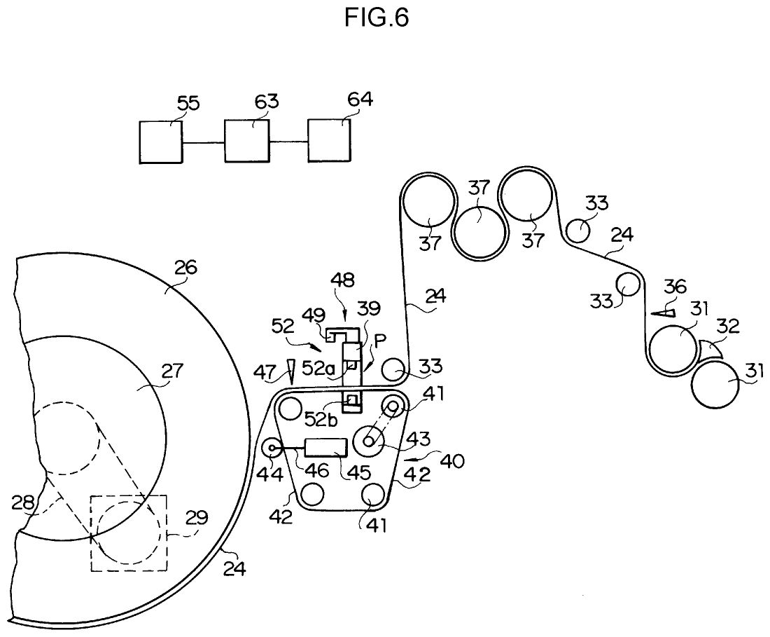

Embodiment 2 of this invention is described next on the basis of FIG. 6. In this embodiment, a difference obtaining section 63 is provided in place of the difference acquiring section 50 in above-described embodiment 1. When the target width and the target thickness are inputted from the storage 55, and further, the measured width and the measured thickness are inputted from the measuring section 48 (the width measuring sensors 49, the thickness measuring sensors 52) to this difference obtaining section 63, from the measured width and the measured thickness (on the basis of the measured width and the measured thickness), the difference obtaining section 63 determines an inferred width and an inferred thickness at each length direction position of the strip-shaped rubber member 24 at the time of being wound on the tire intermediate 26 (infers the width and the thickness after elongation has arisen due to the strip-shaped rubber member 24 of the measured width and the measured thickness being wound onto the tire intermediate 26), while taking into consideration the elongation of the strip-shaped rubber member 24 from the measurement point P until reaching the tire intermediate 26. Further, the difference obtaining section 63 determines the differences between the inferred width and the target width, and, the inferred thickness and the target thickness at each length direction position of the strip-shaped rubber member 24 that have been derived from the above-described target sectional shape. Here, inference such as described above can, in the same way as in embodiment 1, be carried out by using coefficients and computational formulas that are derived from a large amount of data while taking into consideration the wound diameter, the rate of elongation, the material of the rubber, the temperature, the winding speed and the like, or by using a table of theoretical formulas that are derived theoretically or the like.

Visualization of the wound state of the strip-shaped rubber member 24 (the sectional shape of the tread 20 after winding is completed) can be achieved in this way. In addition, even in a case in which the strip-shaped rubber member 24 is pulled and stretched immediately before winding onto the tire intermediate 26, the state of the strip-shaped rubber member 24 at the time of winding, i.e., the differences from the target wound state, can be acquired easily and highly accurately. Further, the above-described differences are successively outputted from the difference obtaining section 63 to a judging section 64. The judging section 64 judges whether or not the differences between the above-described target width, target thickness and inferred width, inferred thickness are less than or equal to tolerances, and judges the quality of the winding of the strip-shaped rubber member 24. Note that other structures and operations are similar to those of above-described embodiment 1, and if detailed description were to be given thereof, explanation would become complicated. Therefore, in this embodiment, merely the same reference numbers are given in FIG. 6 to the same structures, and detailed description thereof is omitted.

### INDUSTRIAL APPLICABILITY

This invention can be applied to industrial fields that overlappingly wind a strip-shaped rubber member plural times onto the outer periphery of a toroidal tire intermediate and form a tread.

Note that the disclosure of Japanese Patent Application No. 2017-30533 filed on Feb. 21, 2017 is, in its entirety, incorporated by reference into the present specification. All publications, patent applications, and technical standards mentioned in the present specification are incorporated by reference into the present specification to the same extent as if such individual publication, patent application, or technical standard was specifically and individually indicated to be incorporated by reference.

1. A method for winding a strip-shaped rubber member that, at a time of overlappingly winding a strip-shaped rubber member plural times onto an outer periphery of a tire intermediate that is toroidal and rotates around an axis, and forming a tread of a target sectional shape, measures a width and a thickness at each length direction position of the strip-shaped rubber member immediately before winding as a measured width and a measured thickness, respectively, at measurement point P that is apart from the tire intermediate, and, from a target width and a target thickness at each length direction position of the strip-shaped rubber member that have been derived from the target sectional shape, determines an estimated width and an estimated thickness at each length direction position of the strip-shaped rubber member at the measurement point P while taking into consideration deformation of the strip-shaped rubber member from the measurement point P until reaching the tire intermediate, and determines differences between the measured width and the estimated width, and between the measured thickness and the estimated thickness, at each corresponding length direction position.

2. A method for winding a strip-shaped rubber member that, at a time of overlappingly winding a strip-shaped rubber member plural times onto an outer periphery of a tire intermediate that is toroidal and rotates around an axis, and forming a tread of a target sectional shape, measures a width and a thickness at each length direction position of the strip-shaped rubber member immediately before winding as a measured width and a measured thickness, respectively, at measurement point P that is apart from the tire intermediate, and, from the measured width and the measured thickness, determines an inferred width and an inferred thickness at each length direction position of the strip-shaped rubber member at a point in time of being wound on the tire intermediate, while taking into consideration deformation of the strip-shaped rubber member from the measurement point P until reaching the tire intermediate, and determines differences, at each corresponding length direction position, between the inferred width and a target width, and between the inferred thickness and a target thickness, of the strip-shaped rubber member that are derived from the target sectional shape.

3. The method for winding a strip-shaped rubber member of claim 1, wherein quality of winding of the strip-shaped rubber member is judged by judging whether or not the differences between the measured width and the estimated width, and between the measured thickness and the estimated thickness, are less than or equal to tolerances.

4. The method for winding a strip-shaped rubber member of claim 2, wherein quality of winding of the strip-shaped rubber member is judged by judging whether or not the differences between the target width and the inferred width, and between the target thickness and the inferred thickness, are less than or equal to tolerances.

5. An apparatus for winding a strip-shaped rubber member comprising: a rotating section that rotates a tire intermediate that is toroidal around an axis; a supplying section that supplies a strip-shaped rubber member to and overlappingly winds the strip-shaped rubber member plural times onto an outer periphery of the tire intermediate, and forms a tread of a target sectional shape; a measuring section that measures a width and a thickness of the strip-shaped rubber member at each length direction position immediately before winding as a measured width and a measured thickness, respectively, at measurement point P that is apart from the tire intermediate;
and a difference acquiring section that, from a target width and a target thickness at each length direction position of the strip-shaped rubber member that have been derived from the target sectional shape, determines an estimated width and an estimated thickness at each length direction position of the strip-shaped rubber member at the measurement point P while taking into consideration deformation of the strip-shaped rubber member from the measurement point P until reaching the tire intermediate, and determines differences between the measured width and the estimated width, and between the measured thickness and the estimated thickness, at each corresponding length direction position.

6. An apparatus for winding a strip-shaped rubber member comprising: a rotating section that rotates a tire intermediate that is toroidal around an axis; a supplying section that supplies a strip-shaped rubber member to and overlappingly winds the strip-shaped rubber member plural times onto an outer periphery of the tire intermediate, and forms a tread of a target sectional shape; a measuring section that measures a width and a thickness at each length direction position of the strip-shaped rubber member immediately before winding as a measured width and a measured thickness, respectively, at measurement point P that is apart from the tire intermediate; and a difference obtaining section that, from the measured width and the measured thickness, determines an inferred width and an inferred thickness at each length direction position of the strip-shaped rubber member at a point in time of being wound on the tire intermediate, while taking into consideration deformation of the strip-shaped rubber member from the measurement point P until reaching the tire intermediate, and determines differences, at each corresponding length direction position, between the inferred width and a target width, and between the inferred thickness and a target thickness, of the strip-shaped rubber member that are derived from the target sectional shape.

7. The apparatus for winding a strip-shaped rubber member of claim 5, wherein plural pairs of width measuring sensors, which are apart in a width direction of the strip-shaped rubber member, which are disposed symmetrically across a width direction center of the strip-shaped rubber member, and which form portions of the measuring section, are set at the measurement point P, and the width of the strip-shaped rubber member is measured by the width measuring sensors that form any of the pairs.

8. The apparatus for winding a strip-shaped rubber member of claim 6, wherein plural pairs of width measuring sensors, which are apart in a width direction of the strip- shaped rubber member, which are disposed symmetrically across a width direction center of the strip-shaped rubber member, and which form portions of the measuring section, are set at the measurement point P, and the width of the strip-shaped rubber member is measured by the width measuring sensors that form any of the pairs.
